(19) United States
(12) Patent Application Publication
(10) Pub. No.: US 2026/0024346 A1
(43) Pub. Date: Jan. 22, 2026

(54) VARIABLE DENSITY IN BIRDS-EYE-VIEW BACKWARD MAPPING

(71) Applicant: QUALCOMM Incorporated, San Diego, CA (US)

(72) Inventors: Mattis Lorentzon, Vikingstad (SE); Gustav Nils Ture Persson, Ljungsbro (SE); Andreas Sjadin Hallstrand, Linköping (SE)

(21) Appl. No.: 18/780,076

(22) Filed: Jul. 22, 2024

(51) Int. Cl. G06V 20/56; G06T 11/00

(52) U.S. Cl. CPC G06V 20/56; G06T 11/005

(57) ABSTRACT

A method for generating a Birds-Eye-View (BEV) space feature map includes obtaining sensor calibration data related to one or more sensors of a vehicle; generating, based on the sensor calibration data, a list of sample positions within a perspective space of the one or more sensors that correspond to a location within Birds-Eye-View (BEV) space; projecting, based on the list of sample positions, the BEV space onto the perspective space of the one or more sensors using variable sample density; and generating a BEV space feature map using the BEV space projected onto the perspective space of the one or more sensors.

### TECHNICAL FIELD

This disclosure relates to image processing.

### BACKGROUND

Among other challenges, autonomous driving systems need to accurately detect and track moving objects such as vehicles, pedestrians, and cyclists in real time. In autonomous driving, accurately estimating the state of surrounding obstacles is critical for safe and robust path planning. However, this perception task is difficult, particularly for generic obstacles, due to appearance and occlusion changes. Perceptual errors can manifest as braking and swerving maneuvers that can be unsafe and uncomfortable. Many contemporary autonomous driving systems utilize a “detect then track” approach to perceive the state of objects in the environment. This approach has strongly benefited from recent advancements in 3-D object detection and state estimation. However, this approach often suffers errors as it relies on geometric consistency of the object detection results over time.

### SUMMARY

In general, this disclosure describes techniques for backward mapping with variable sample density. Every Birds Eye View (BEV) position may get sampled at least once. Such sampling may ensure there is information from each sensor within each sensor's field of view for every point in the BEV space, even if a particular point is far away. In an aspect, areas closer to the sensors may have a higher sample density. In other words, increased sample frequency near sensors may capture information-rich details from the sensors more accurately. For BEV positions with high sample density (sampled more than once) each position may be divided into sub-positions. Each sub-position may then be projected back onto the sensor space. These sub-positions in the sensor space may become the actual sampling points for the sensor data. The sensor data at the sampling points may then be used for bilinear resampling to obtain the final feature value for the BEV position. The variable sample density technique in backward mapping may also be adapted to sensors with different optical properties. For example, the disclosed technique may be adapted to narrow Field of View (FOV) camera, which captures details well at further distances but has a limited view area. In one aspect, the disclosed techniques may also be adapted to standard sensors, which are likely to have a wider FOV but may not capture details as well at a distance.

In an aspect, the disclosed techniques may provide densely populated BEV feature maps. Every BEV position may have information, improving overall BEV feature map quality. As yet another non-limiting advantage, the disclosed techniques may preserve information density near sensors. Increased sampling may capture details important for perception tasks.

In one example, a method for generating a Birds-Eye-View (BEV) space feature map includes obtaining sensor calibration data related to one or more sensors of a vehicle; generating, based on the sensor calibration data, a list of sample positions within a perspective space of the one or more sensors that correspond to a location within Birds-Eye-View (BEV) space; projecting, based on the list of sample positions, the BEV space onto the perspective space of the one or more sensors using variable sample density; and generating a BEV space feature map using the BEV space projected onto the perspective space of the one or more sensors.

In another example, an apparatus for generating a BEV space feature map includes a memory for storing sensor data; and processing circuitry in communication with the memory. The processing circuitry is configured to obtain sensor calibration data related to one or more sensors of a vehicle and to generate, based on the sensor calibration data, a list of sample positions within a perspective space of the one or more sensors. Each of the sample positions corresponds to at least a location within BEV space. The processing circuitry is also configured to project, based on the list of sample positions, the BEV space onto the perspective space of the one or more sensors using variable sample density and to generate a BEV space feature map using the BEV space projected onto the perspective space of the one or more sensors.

In yet another example, non-transitory computer-readable storage media having instructions encoded thereon, the instructions configured to cause processing circuitry to: obtain sensor calibration data related to one or more sensors of a vehicle and to generate, based on the sensor calibration data, a list of sample positions within a perspective space of the one or more sensors. Each of the sample positions corresponds to at least a location within BEV space. Additionally, the instructions are configured to cause the processing circuitry to project, based on the list of sample positions, the BEV space onto the perspective space of the one or more sensors using variable sample density and to generate a BEV space feature map using the BEV space projected onto the perspective space of the one or more sensors.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a diagram of an example autonomous vehicle, in accordance with the techniques of this disclosure.

FIG. 2 is a block diagram illustrating an example system that may perform the techniques of this disclosure.

FIG. 3 shows an image representing the number of distributed perspective view positions for each BEV position when using forward mapping.

FIG. 4 shows an image representing the number of sampled perspective view positions for each BEV position when using backward mapping.

FIG. 5 shows an image illustrating backward mapping with variable sample density, in accordance with the techniques of this disclosure.

FIG. 6 is a block diagram illustrating implementation of the backward mapping with variable sample density, in accordance with the techniques of this disclosure.

FIG. 7 is a block diagram illustrating generation of sensor sample positions, in accordance with the techniques of this disclosure.

FIG. 8 is a block diagram illustrating generation of BEV space features, in accordance with the techniques of this disclosure.

FIG. 9 is a flowchart illustrating an example method for generating a BEV space feature map in accordance with the techniques of this disclosure.

### DETAILED DESCRIPTION

Autonomous driving systems and/or advanced driving assistance systems (ADAS) rely on various sensors like cameras, LiDAR, radar, etc., each with its strengths and weaknesses. Cameras may provide rich visual information but may struggle in low light or challenging weather. LiDAR may offer accurate distance measurements but may have limited range or be sensitive to rain. Radar may excel at detecting objects in all weather conditions but may lack detailed visual information. A low level fusion approach combines sensor data before any high-level processing like object detection or classification. The goal of low-level fusion is to create a more comprehensive and robust understanding of the environment by leveraging the combined strengths of different sensors.

A common representation used in low-level fusion is the BEV space. A low level fusion may fuse camera data (pixels) with LiDAR data (point clouds). The low level fusion approach may get the strengths of both sensors (camera for visuals, LiDAR for depth) in their raw format. Furthermore, the low-level fusion may combine the raw image data from multiple sensors of the same type (e.g., cameras) potentially stitching them together for a wider field of view or 3D reconstruction. BEV space is similar to looking down from directly above the vehicle. Representing data in the BEV space may transform sensor data into a top-down, 2D grid map representing the surrounding area. By combining data from multiple sensors, the BEV map may be more robust to individual sensor weaknesses. For example, LiDAR may fill in missing details from cameras in low light. Features extracted from the BEV map may be used for more accurate object detection and classification (e.g., identifying pedestrians, vehicles, traffic signals). The BEV map may provide a comprehensive view of the surroundings, allowing the self-driving vehicle to make informed decisions about navigation and obstacle avoidance. Sensor modality-specific fusion may involve processing camera images, LiDAR point clouds, and radar signals separately before combining them in the BEV space. Feature-level fusion may extract features like edges, lines, and object shapes from each sensor data and may then fuse them in the BEV space.

Two common approaches for low level perception fusion in a BEV space, are the forward mapping and backward mapping. In the forward mapping approach, individual sensor measurements are directly transformed into the BEV space. Forward mapping typically involves finding the corresponding location in the BEV space for each sensor feature and assigning feature value of the corresponding sensor measurement to that location (e.g., a point). Each sensor data point (e.g., pixel from a camera, distance measurement from LiDAR) may be transformed based on the sensor's position and orientation (calibration data). The transformed data point may then be projected onto the corresponding location in the BEV space grid. A common method for performing forward mapping is nearest neighbor rounding. In other words, the feature value is assigned to the closest point in the BEV grid, potentially causing information loss due to rounding errors.

The backward mapping approach, projects the BEV space back onto the sensor space for each sensor. For a given BEV position, the system may backtrack to each sensor using the sensor calibration data. The system may determine the location (sample position) within the perspective space of the sensor (camera image, LiDAR point cloud) that corresponds to the BEV position. Data from that sample position in the sensor space may be used to represent the BEV location. Techniques like bilinear interpolation may be used for non-integer sample positions. The backward mapping approach considers the values of neighboring pixels in the sensor data to assign a more accurate feature value for the corresponding point in the BEV. Accordingly, one of the key differences between the forward mapping and backward mapping is transformation direction: in forward mapping the feature positions are transformed from the sensor space to the BEV space, while in backward mapping the feature positions are transformed from the BEV space to the sensor space.

Furthermore, the common approach for the forward mapping is nearest neighbor, while the common approach for the backward mapping is bilinear interpolation. The advantage of the forward mapping approach is simpler implementation, while the advantage of the backward mapping is potentially higher accuracy. The disadvantage of the forward mapping approach is potential loss of information due to rounding, while the disadvantage of the backward mapping is more complex calculations. The choice between these approaches may depend on the specific application and the trade-off between accuracy and computational efficiency.

Both forward and backward mapping have limitations when dealing with the sparsity difference between sensor spaces and the BEV space. As mentioned above, in forward mapping features from sensors get “splattered” directly onto the BEV space. This leads to a concentration of information (dense packing) in areas close to the sensor location in the BEV. Since sensors typically have a limited range, areas further away in the BEV receive no information or very little information due to rounding errors. This creates sparse or even empty regions in the BEV.

Bilinear interpolation in backward mapping attempts to distribute sensor information more evenly across the entire BEV space. However, the bilinear interpolation process can smooth out details and potentially lose valuable information captured by the sensors, especially close to their location. As an analogy, forward mapping is like gathering all the witness statements directly at the crime scene (sensor space). There is a lot of detail near the scene but limited information about what happened further away.

Backward mapping is like interviewing witnesses from their homes (BEV space). One may get a broader picture, but details from the immediate scene might be blurry or missing. The disclosed technique leverages the strengths of both approaches.

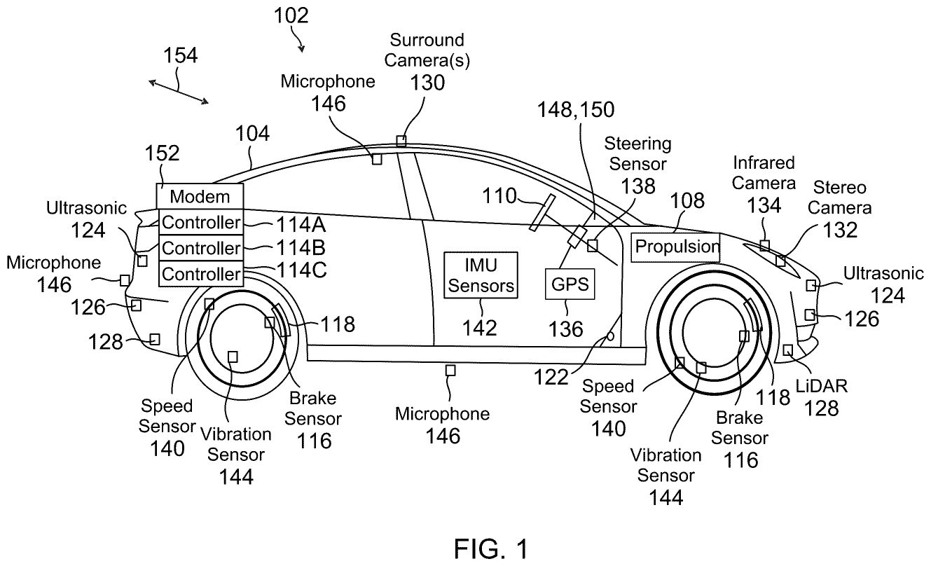

FIG. 1 shows an example vehicle 102. Vehicle 102 in the example shown may comprise a passenger vehicle such as a car or truck that can accommodate a human driver and/or human passengers. In an aspect, vehicle 102 may comprise an autonomous vehicle, semi-autonomous vehicle and/or vehicle with an ADAS system. Vehicle 102 may include a vehicle body 104 suspended on a chassis, in this example comprised of four wheels and associated axles. A propulsion system 108 such as an internal combustion engine, hybrid electric power plant, or even all-electric engine may be connected to drive some or all of the wheels via a drive train, which may include a transmission (not shown). A steering wheel 110 may be used to steer some or all of the wheels to direct vehicle 102 along a desired path when the propulsion system 108 is operating and engaged to propel the vehicle 102. Steering wheel 110 or the like may be optional for Level 5 implementations. One or more controllers 114A-114C (a controller 114) may provide autonomous capabilities in response to signals continuously provided in real-time from an array of sensors, as described more fully below.

Each controller 114 may be essentially one or more onboard computers that may be configured to perform deep learning and/or artificial intelligence functionality and output autonomous operation commands to self-drive vehicle 102 and/or assist the human vehicle driver in driving. Each vehicle may have any number of distinct controllers for functional safety and additional features. For example, controller 114A may serve as the primary computer for autonomous driving functions, controller 114B may serve as a secondary computer for functional safety functions, controller 114C may provide artificial intelligence functionality for in-camera sensors, and controller 114D (not shown) may provide infotainment functionality and provide additional redundancy for emergency situations.

Controller 114 may send command signals to operate vehicle brakes 116 via one or more braking actuators 118, operate steering mechanism via a steering actuator, and operate propulsion system 108 which also receives an accelerator/throttle actuation signal 122. Actuation may be performed by methods known to persons of ordinary skill in the art, with signals typically sent via the Controller Area Network data interface (“CAN bus”)—a network inside modern cars used to control brakes, acceleration, steering, windshield wipers, and the like. The CAN bus may be configured to have dozens of nodes, each with its own unique identifier (CAN ID). The bus may be read to find steering wheel angle, ground speed, engine RPM, button positions, and other vehicle status indicators. The functional safety level for a CAN bus interface is typically Automotive Safety Integrity Level (ASIL) B. Other protocols may be used for communicating within a vehicle, including FlexRay and Ethernet.

In an aspect, an actuation controller may be obtained with dedicated hardware and software, allowing control of throttle, brake, steering, and shifting. The hardware may provide a bridge between the vehicle's CAN bus and the controller 114, forwarding vehicle data to controller 114 including the turn signal, wheel speed, acceleration, pitch, roll, yaw, Global Positioning System (“GPS”) data, tire pressure, fuel level, sonar, brake torque, and others. Similar actuation controllers may be configured for any other make and type of vehicle, including special-purpose patrol and security cars, robo-taxis, long-haul trucks including tractor-trailer configurations, tiller trucks, agricultural vehicles, industrial vehicles, and buses.

Controller 114 may provide autonomous driving outputs in response to an array of sensor inputs including, for example: one or more ultrasonic sensors 124, one or more RADAR sensors 126, one or more LiDAR sensors 128, one or more surround cameras 130 (typically such cameras are located at various places on vehicle body 104 to image areas all around the vehicle body), one or more stereo cameras 132 (in an aspect, at least one such stereo camera may face forward to provide object recognition in the vehicle path), one or more infrared cameras 134, GPS unit 136 that provides location coordinates, a steering sensor 138 that detects the steering angle, speed sensors 140 (one for each of the wheels), an inertial sensor or inertial measurement unit (“IMU”) 142 that monitors movement of vehicle body 104 (this sensor can be for example an accelerometer(s) and/or a gyro-sensor(s) and/or a magnetic compass(es)), tire vibration sensors 144, and microphones 146 placed around and inside the vehicle. Other sensors may be used, as is known to persons of ordinary skill in the art.

Controller 114 may also receive inputs from an instrument cluster 148 and may provide human-perceptible outputs to a human operator via human-machine interface (“HMI”) display(s) 150, an audible annunciator, a loudspeaker and/or other means. In addition to traditional information such as velocity, time, and other well-known information, HMI display 150 may provide the vehicle occupants with information regarding maps and vehicle's location, the location of other vehicles (including an occupancy grid) and even the Controller's identification of objects and status. For example, HMI display 150 may alert the passenger when the controller has identified the presence of a stop sign, caution sign, or changing traffic light and is taking appropriate action, giving the vehicle occupants peace of mind that the controller 114 is functioning as intended.

In an aspect, instrument cluster 148 may include a separate controller/processor configured to perform deep learning and artificial intelligence functionality.

Vehicle 102 may collect data that is preferably used to help train and refine the neural networks used for autonomous driving. The vehicle 102 may include modem 152, preferably a system-on-a-chip that provides modulation and demodulation functionality and allows the controller 114 to communicate over the wireless network 154. Modem 152 may include an RF front-end for up-conversion from baseband to RF, and down-conversion from RF to baseband, as is known in the art. Frequency conversion may be achieved either through known direct-conversion processes (direct from baseband to RF and vice-versa) or through super-heterodyne processes, as is known in the art. Alternatively, such RF front-end functionality may be provided by a separate chip. Modem 152 preferably includes wireless functionality substantially compliant with one or more wireless protocols such as, without limitation: LTE, WCDMA, UMTS, GSM, CDMA2000, or other known and widely used wireless protocols.

It should be noted that, compared to sonar and RADAR sensors 126, cameras 130-134 may generate a richer set of features at a fraction of the cost. Thus, vehicle 102 may include a plurality of cameras 130-134, capturing images around the entire periphery of the vehicle 102. Camera type and lens selection depends on the nature and type of function. The vehicle 102 may have a mix of camera types and lenses to provide complete coverage around the vehicle 102; in general, narrow lenses do not have a wide field of view but can see farther. All camera locations on the vehicle 102 may support interfaces such as Gigabit Multimedia Serial link (GMSL) and Gigabit Ethernet.

In an aspect, a controller 114 may start by gathering sensor calibration data related to one or more sensors 126-134 of the vehicle 102. For example, sensors may include cameras 130-134, LiDAR sensors 128, RADAR sensors 126, or a combination of these. Each sensor may have a specific perspective it captures, like field of view of cameras 130-134. Sensor calibration data may indicate exactly how this perspective relates to the real world. Sensor calibration data may include, but is not limited to, field of view (the angular area each sensor “sees”), distortion (how the sensor may slightly bend or warp the image it captures, position and orientation (where the sensor is mounted on the car and how it is tilted or angled). Next, controller 114 may generate, based on the obtained sensor calibration data, a list of sample positions 606 within a perspective space of the one or more sensors that correspond to a location within Birds-Eye-View (BEV) space. These positions may represent specific points within the BEV space (like a grid). This step is very important. In other words, controller 114 may take each sample position in BEV space and project it back onto the perspective space of the sensor (the image a camera sees or the point cloud a LiDAR generates). Advantageously, the density of these projections may be variable. In other words, areas of the BEV space that are important, like those close to the vehicle, may have more sample positions projected onto the sensor view for better detail. Conversely, areas farther away may have fewer samples. Finally, controller 114 may generate a BEV space feature map 608 using the BEV space sampling positions projected onto the perspective space of the one or more sensors. By combining sensor data across all sample positions, controller 114 may build the BEV feature map. The BEV feature map may essentially provide a top-down view of the surroundings with additional information about the objects (e.g., their type, location).

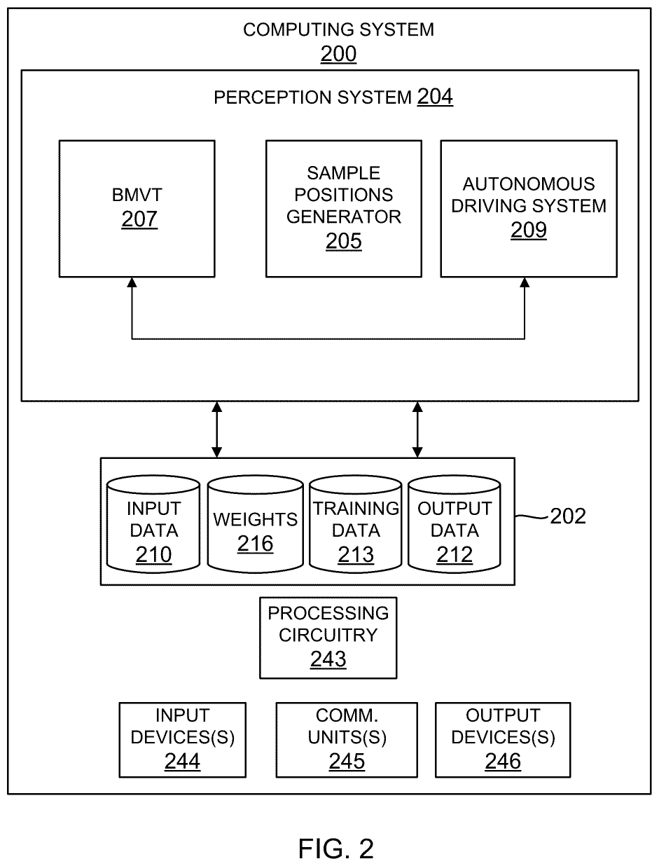

FIG. 2 is a block diagram illustrating an example computing system 200. As shown, computing system 200 comprises processing circuitry 243 and memory 202 for executing an example perception system 204, which may represent an example instance of any controller 114 described in this disclosure, such as controller 114 of FIG. 1. In an aspect, perception system 204 may include, but is not limited to sample positions generator 205 and Backward Mapping View Transform (BMVT) unit 207. Perception system 204 may further include an autonomous driving system 209 which may comprise various types of neural networks, such as, but not limited to, recursive neural networks (RNNs), convolutional neural networks (CNNs), and deep neural networks (DNNs). For example, autonomous driving system 209 may include an object detection model.

Computing system 200 may also be implemented as any suitable external computing system accessible by controller 114, such as one or more server computers, workstations, laptops, mainframes, appliances, cloud computing systems, High-Performance Computing (HPC) systems (i.e., supercomputing) and/or other computing systems that may be capable of performing operations and/or functions described in accordance with one or more aspects of the present disclosure. In some examples, computing system 200 may represent a cloud computing system, server farm, and/or server cluster (or portion thereof) that provides services to client devices and other devices or systems. In other examples, computing system 200 may represent or be implemented through one or more virtualized compute instances (e.g., virtual machines, containers, etc.) of a data center, cloud computing system, server farm, and/or server cluster.

The techniques described in this disclosure may be implemented, at least in part, in hardware, software, firmware or any combination thereof. For example, various aspects of the described techniques may be implemented within processing circuitry 243 of computing system 200, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

In another example, computing system 200 comprises any suitable computing system having one or more computing devices, such as desktop computers, laptop computers, gaming consoles, smart televisions, handheld devices, tablets, mobile telephones, smartphones, etc. In some examples, at least a portion of computing system 200 is distributed across a cloud computing system, a data center, or across a network, such as the Internet, another public or private communications network, for instance, broadband, cellular, Wi-Fi, ZigBee, Bluetooth® (or other personal area network-PAN), Near-Field Communication (NFC), ultrawideband, satellite, enterprise, service provider and/or other types of communication networks, for transmitting data between computing systems, servers, and computing devices.

Memory 202 may comprise one or more storage devices. One or more components of computing system 200 (e.g., processing circuitry 243, memory 202, etc.) may be interconnected to enable inter-component communications (physically, communicatively, and/or operatively). In some examples, such connectivity may be provided by a system bus, a network connection, an inter-process communication data structure, local area network, wide area network, or any other method for communicating data. Processing circuitry 243 of computing system 200 may implement functionality and/or execute instructions associated with computing system 200. Examples of processing circuitry 243 include microprocessors, application processors, display controllers, auxiliary processors, one or more sensor hubs, and any other hardware configured to function as a processor, a processing unit, or a processing device. Computing system 200 may use processing circuitry 243 to perform operations in accordance with one or more aspects of the present disclosure using software, hardware, firmware, or a mixture of hardware, software, and firmware residing in and/or executing at computing system 200. The one or more storage devices of memory 202 may be distributed among multiple devices.

Memory 202 may store information for processing during operation of computing system 200. In some examples, memory 202 comprises temporary memories, meaning that a primary purpose of the one or more storage devices of memory 202 is not long-term storage. Memory 202 may be configured for short-term storage of information as volatile memory and therefore not retain stored contents if deactivated. Examples of volatile memories include random access memories (RAM), dynamic random-access memories (DRAM), static random-access memories (SRAM), and other forms of volatile memories known in the art. Memory 202, in some examples, may also include one or more computer-readable storage media. Memory 202 may be configured to store larger amounts of information than volatile memory. Memory 202 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories. Memory 202 may store program instructions and/or data associated with one or more of the modules or units described in accordance with one or more aspects of this disclosure.

Processing circuitry 243 and memory 202 may provide an operating environment or platform for one or more modules or units (e.g., sample positions generator 205 and BMVT unit 207), which may be implemented as software, but may in some examples include any combination of hardware, firmware, and software. Processing circuitry 243 may execute instructions and the one or more storage devices, e.g., memory 202, may store instructions and/or data of one or more modules or units. The combination of processing circuitry 243 and memory 202 may retrieve, store, and/or execute the instructions and/or data of one or more applications, modules, or software. The processing circuitry 243 and/or memory 202 may also be operably coupled to one or more other software and/or hardware components, including, but not limited to, one or more of the components illustrated in FIG. 2.

Processing circuitry 243 may execute perception system 204 using virtualization modules, such as a virtual machine or container executing on underlying hardware. One or more of such modules may execute as one or more services of an operating system or computing platform. Aspects of perception system 204 may execute as one or more executable programs at an application layer of a computing platform.

One or more input devices 244 of computing system 200 may generate, receive, or process input. Such input may include input from a video camera, sensor, keyboard, pointing device, voice responsive system, biometric detection/response system, button, mobile device, control pad, microphone, presence-sensitive screen, network, or any other type of device for detecting input from a human or machine.

One or more output devices 246 may generate, transmit, or process output. Examples of output are tactile, audio, visual, and/or video output. Output devices 246 may include a display, sound card, video graphics adapter card, speaker, presence-sensitive screen, one or more USB interfaces, video and/or audio output interfaces, or any other type of device capable of generating tactile, audio, video, or other output. Output devices 246 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 244 and one or more output devices 246.

One or more communication units 245 of computing system 200 may communicate with devices external to computing system 200 (or among separate computing devices of computing system 200) by transmitting and/or receiving data, and may operate, in some respects, as both an input device and an output device. In some examples, communication units 245 may communicate with other devices over a network. In other examples, communication units 245 may send and/or receive radio signals on a radio network such as a cellular radio network. Examples of communication units 245 include a network interface card (e.g., such as an Ethernet card), an optical transceiver, a radio frequency transceiver, a GPS receiver, or any other type of device that can send and/or receive information. Other examples of communication units 245 may include Bluetooth®, GPS, 3G, 4G, and Wi-Fi® radios found in mobile devices as well as Universal Serial Bus (USB) controllers and the like.

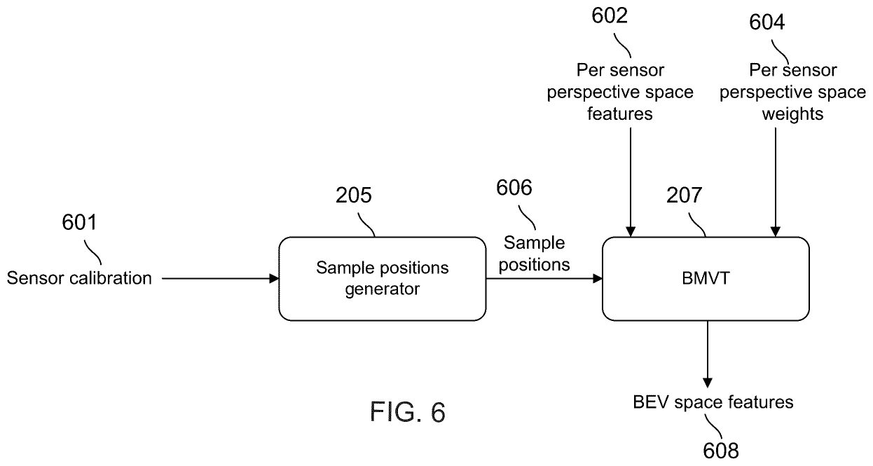

In the example of FIG. 2, sample positions generator 205 may be configured to generate sample positions, as described herein. Sample positions generator 205 and BMVT unit 207 may receive input data 210. Sample positions generator 205 may receive input from sensors such as, but not limited to, cameras 130-134, LiDAR sensor(s) 128, RADAR sensors 126, and/or ultrasonic sensors 124. BMVT unit 207 may generate output data 212. Output data generated by sample positions generator 205 (e.g., a list of sample positions specific to the sensor for the given BEV output position) may be used as input data for BMVT unit 207 of the perception system 204 (as shown in FIG. 6). Input data 210 and output data 212 may contain various types of information. For example, input data 210 may include, but is not limited to, sensor calibration data, perspective features data (sensor data), perspective space weights data, and so on. Output data 212 may include generated BEV space features, BEV space feature map, and so on.

For each sensor, the BMVT unit 207 may use the generated sample positions and sensor calibration data to project those positions back onto the perspective space of the sensor (e.g., camera image, LiDAR point cloud). The BMVT unit 206 may project the BEV space back onto the perspective space of each sensor. Bilinear interpolation is a method for estimating the value of a data point at a specific location within a two-dimensional grid. The sensor data (e.g., camera image or LiDAR point cloud) may be represented as a grid where each pixel or point represents a specific location in the sensor's view. The data associated with each pixel/point is like the height of the grid at that location. The sample positions from the BEV space, when projected onto the sensor view, may not always land exactly on a grid point. The sample positions could fall somewhere in between existing points. In an example, the BMVT unit 207 may take the four nearest grid points surrounding the off-grid sample position and their corresponding data values. Based on the position of the sample point relative to these four neighbors, BMVT unit 207 may calculate a weighted average of their data values. This weighted average may become the estimated value assigned to the off-grid sample position. The BMVT unit 207 may use the weights to influence the contribution of each sample position during the interpolation, potentially giving more weight to areas with higher information density, as described below. The output generated by the BMVT unit 207 may comprise the final BEV space feature map.

Using the received BEV space feature data, autonomous driving system 209 (the control system of the vehicle 102) may generate a real-time map of surroundings of vehicle 102 and may identify potential obstacles or traffic signals. The generated BEV space feature data, with its high-resolution areas, may become the primary source of information for the autonomous driving system 209 (e.g., ADAS system). The autonomous driving system 209 may analyze the feature map to understand the surrounding environment in detail, particularly focusing on the areas with increased sampling rate. Based on this detailed understanding, the autonomous driving system 209 may make decisions about appropriate actions. Such decisions may include, but are not limited to: warning the driver of potential hazards (e.g., pedestrians crossing the street); providing steering or braking assistance to maintain lane position or avoid collisions; adapting cruise control speed based on surrounding traffic.

In an aspect, the disclosed techniques may capture detailed information close to the sensors while maintaining a good level of coverage throughout the BEV space.

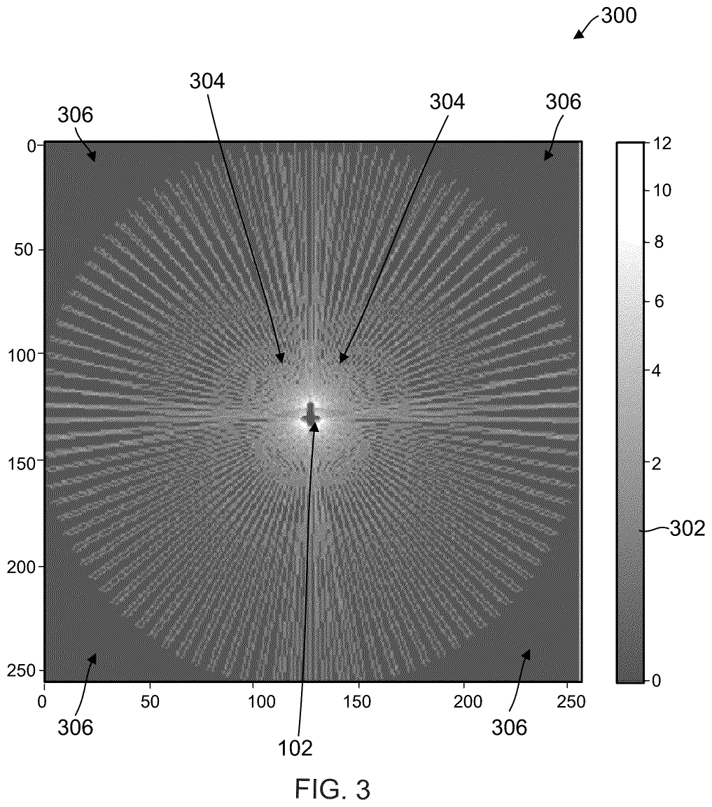

FIG. 3 shows image 300 representing the number of distributed perspective view positions when using forward mapping. The image 300 in FIG. 3 shows a color gradient or values 302 (0-12 in this example) indicating the density of data points contributing to each BEV location. The context illustrated in FIG. 3 may be using forward mapping for low-level perception fusion with four wide FOV cameras. As noted above, forward mapping involves projecting sensor data directly onto the BEV space. Cameras with a wide field of view may capture a larger area but with potentially lower resolution details. The image 300 shows that many BEV positions may receive data from zero up to 12 perspective views (camera locations). Areas 304 closer to the cameras (in the BEV) may likely have a higher density of contributing perspective views (higher values in the image 300). In other words, lots of data points may be collected for each position in the areas 304 closer to the cameras. This is because multiple wide FOV cameras will overlap and project data onto these BEV locations. The BEV space may be viewed as a grid with very small squares, and each square has detailed information. For the locations 306 further away from the vehicle 102 in the BEV, the data collection becomes sparser (lower values or even zero). The pattern shown in FIG. 3 is like a fan opening up. The closer the location is to the hinge (the vehicle 102), the more data points are available. As one moves towards the outer edges of the fan (farther from the vehicle 102), there may be less and less information. There may be almost no data collected in the locations 306 far away from the vehicle 102. It is like the far reaches of the fan where the information “blades” may disappear completely. It should be noted that the number of contributing perspective views may likely decrease because wide FOV cameras may not capture details at a distance, and their coverage area may shrink as the distance increases.

In an aspect, many BEV positions, especially those far from all cameras, may receive no data at all (represented by the locations 306 in the image).

As explained earlier, forward mapping with wide FOV cameras may lead to many BEV positions receiving little or no data, especially further from the cameras. In the example illustrated in FIG. 3, the 256×256 grid size may cover a significant area (−50 to 50 meters) in lateral and longitudinal direction. In other words, even areas with some camera coverage might have sparse data compared to the overall size.

Later stages of the perception system 204 (e.g., object detection) may perform additional processing to compensate for missing information. This can be computationally expensive and reduce the overall quality of the processed signal (features) in the BEV map. Sparse data in the BEV map may lead to inaccurate perception of the environment, potentially missing objects or misjudging their location and size. The lack of information further away may limit the ability of vehicle 102 to detect and plan for distant obstacles.

Compensating for missing data in later stages may slow down the processing pipeline, impacting real-time decision making for vehicle 102. In an aspect, variable sample density technique may be used in backward mapping to ensure all BEV positions receive data while focusing on higher sampling near the sensors to capture details.

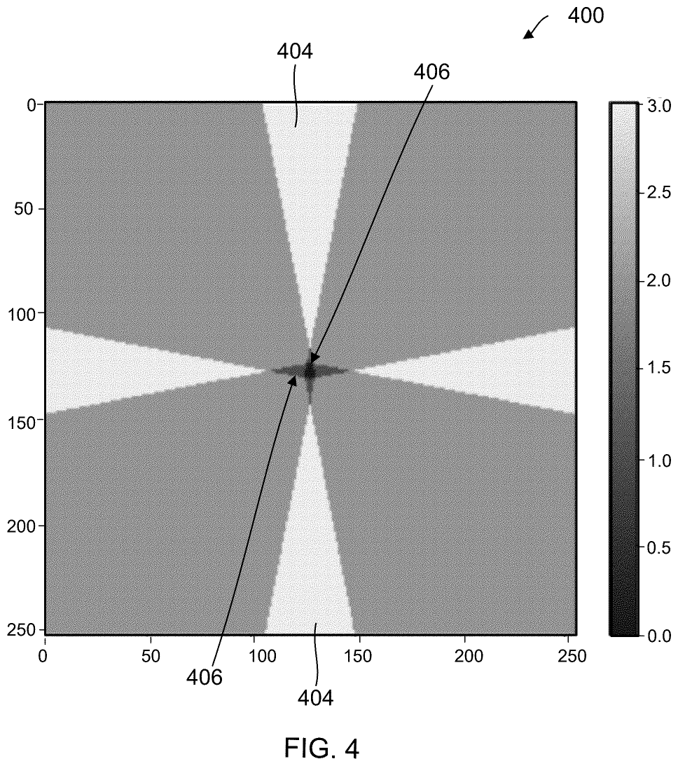

FIG. 4 shows image 400 representing the number of sampled perspective view positions for each BEV position when using backward mapping. The image 400 illustrates how many camera locations contributed data to a specific point in the BEV space. As discussed earlier, BEV space may represent the environment in a top-down perspective like a grid. Each cell in this grid may correspond to a specific location in the real world. The context illustrated in FIG. 4 may be using backward mapping for low-level perception fusion with four wide FOV cameras.

The backward mapping approach projects the BEV space back onto the sensor space (cameras) for data sampling. Standard cameras typically have a narrower field of view, meaning they capture a smaller portion of the scene in detail. Wide FOV cameras, on the other hand, may capture a much wider area, which is beneficial for capturing a larger portion of the surroundings. However, this wider view may come at a cost. Objects towards the edges of a wide FOV camera's image often appear distorted compared to objects in the center. Such distortion may be due to the way the lens projects the scene onto the image sensor. When projecting the positions from the BEV space (which assumes a perfect top-down view) onto the perspective of the wide FOV camera, additional processing may be performed to account for the distortion. Bilinear interpolation, while effective for regular grids, may not be sufficient due to the non-uniform nature of the wide FOV image. The image 400 shows a gradient of values 402 (1-3 in this example) indicating the number of contributing cameras for each BEV location. Areas 404 in the BEV that overlap the FOV of multiple cameras (higher values in the image) may have data sampled from 1 to 3 camera viewpoints. This is because backward mapping ensures every BEV position gets information from at least one camera, if covered by the field of view, and in areas 404 with overlap, a particular BEV position may get contributions from several cameras. Areas 406 with minimal overlap may still receive data from 1 camera (the closest one with some FOV coverage). As noted above, BEV may represent the surrounding environment from a top-down perspective, like looking at a map. In this context, the BEV space refers to a digital grid that may represent the area around the vehicle 102. Each cell in the grid may correspond to a specific location in the real world.

Overall, the image 400 shows a more even distribution of data points in the BEV space compared to forward mapping image 300 with wide FOV cameras. This is an advantage of backward mapping, especially when combined with bilinear interpolation. The bilinear interpolation technique in backward mapping may use information from neighboring pixels in the sensor data to create a more accurate feature value for the BEV position, even with a single contributing camera. Compared to forward mapping, backward mapping with wide FOV cameras may potentially create a BEV map with more data points and potentially less sparse areas. Later stages of the perception system 204 (e.g., object detection) may require less processing to compensate for missing information, improving efficiency. In the illustrated example, while backward mapping improves coverage, information density may still be lower compared to areas directly observed by multiple cameras. The quality of information in the BEV ultimately depends on the capabilities of the sensors themselves (resolution, range, etc.).

Backward mapping ensures every BEV position is sampled, leading to a denser overall map compared to forward mapping with wide FOV cameras. However, this approach treats all positions equally, using the same sampling frequency for both areas close to the sensors (rich in detail) and those further away (potentially less detailed). In simpler terms, backward mapping is like taking a single blurry picture of a scene, ensuring the whole scene is captured but lacking detail. Forward mapping (ideally) would be like taking multiple high-resolution pictures focused on different areas, providing detailed information near the sensors but potentially missing some parts. As noted above, maintaining a high sampling frequency throughout the BEV may be computationally expensive, especially for areas far from the sensors where the information gain may be minimal. It should be noted that the disclosed herein variable sample density technique may leverage the strengths of backward mapping while maintaining detail sensitivity. In an aspect, the disclosed technique may ensure that all BEV positions are sampled at least once (typically with bilinear interpolation). However, for areas closer to the sensors (with higher information density from the cameras), the sampling frequency may be increased. For BEV positions with sensor overlap (e.g. areas 404), the corresponding positions may be virtually divided into sub-positions. These sub-positions may then be projected back onto the sensor space, essentially increasing the sampling rate near the cameras. The sensor data at these sub-positions may be used with bilinear interpolation to obtain a more detailed feature value for the original BEV position. To utilize the newly created sub-positions in sensor processing, the perception system 204 needs to project them onto the perspective of the sensor. Bilinear interpolation is a mathematical technique that estimates the value at a specific point based on the values of its surrounding points. In this case, bilinear interpolation may be used to determine the data for each sub-position based on the data from surrounding sample positions in the perspective space of a sensor.

In an aspect, the aforementioned variable sample density technique may maintain the advantage of a densely populated BEV space. In an aspect, the variable sample density technique may capture detailed information close to the sensors with higher sampling frequency. In an aspect, less frequent sampling for areas with potentially less informative data may improve efficiency.

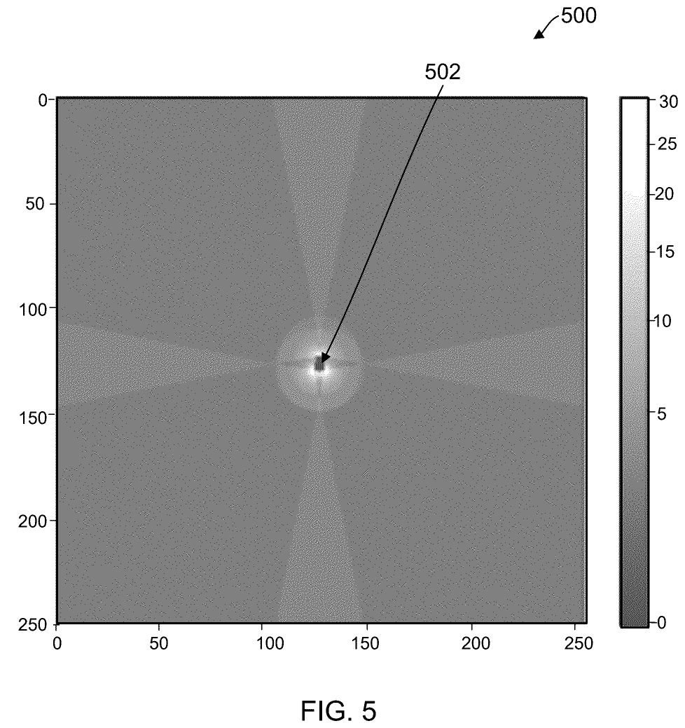

FIG. 5 shows image 500 illustrating backward mapping with variable sample density, in accordance with the techniques of this disclosure.

An example traditional approach uses backward mapping with bilinear interpolation to project the BEV space onto sensor space for data sampling. Advantageously, backward mapping ensures every output position has at least one corresponding sample, eliminating blank spots. However, sensors typically capture more data points closer to them. Backward mapping only utilizes one sample per sensor for each output, regardless of the data density of the sensor. Accordingly, the example traditional approach may discard potentially valuable high-resolution data near the sensors. In an aspect, the disclosed techniques herein leverage backward mapping while addressing its limitations. In an aspect, the variable sample density technique may ensure that every BEV position is sampled at least once (typically with bilinear interpolation) for each sensor with overlapping FOV. However, for areas 502 closer to the sensors (with potentially higher information density), the sampling frequency may be increased. The backward mapping technique better ensures at least one sample for every output position. Instead of pre-determining sample points, the disclosed technique may project the output position onto each sensor. The sampling location on the sensor may be determined by the projection. This better ensures every output position overlaps with at least one sensor measurement.

Backward mapping better ensures all BEV positions are sampled, but perception system 204 may be configured to capture more detail near the sensors. Some BEV positions may have a higher designated “sample frequency” than 1. In simpler terms, some BEV positions should be sampled more than once to extract richer information. For BEV positions with significant sensor FOV overlap (with a sample frequency greater than 1), perception system 204 may virtually divide the position into sub-positions. These sub-positions may then be projected back onto the sensor space, essentially increasing the sampling rate near the cameras. The sensor data at these sub-positions may be used with bilinear interpolation to obtain a more detailed feature value for the original BEV position. Backward mapping prioritizes covering the entire output space with at least one sample. Backward mapping may sacrifice pre-defined sampling points for a more complete picture. Even with backward mapping, sampling positions may still be pre-defined to an extent. As long as the sensor calibration data is available, perception system 204 may pre-compute a set of sample positions that are guaranteed to cover a specific area of the BEV space. The disclosed technique may be useful when missing data points are undesirable.

The number of sub-positions created may depend on the specific sample frequency. For example, a sample frequency of 4 would result in a 2×2 grid of sub-positions within the original BEV position. In an aspect, the perception system 204 may then project each of these sub-positions back onto the sensor space (cameras, LiDAR, etc.) and sample the features using techniques like bilinear interpolation. As noted above, vehicle 102 may use various sensors like cameras and LiDAR to capture the environment. Each sensor may have its own perspective (sensor space). As noted above, projection to sensor space may essentially increase the sampling rate in areas 502 close to the sensors where information density is higher. In an aspect, the sampling rate may be increased in specific regions within the BEV space where the detail is important. Examples may include, but are not limited to, areas close to the vehicle 102 (for collision avoidance) or areas with potentially moving objects (like pedestrians).

In an aspect, sensor data at these sub-positions in sensor space may be used for bilinear resampling. In an aspect, bilinear resampling may consider information from neighboring pixels to create a more accurate and detailed feature value for the original BEV position.

In an aspect, by increasing the sampling rate near sensors, the disclosed technique may allow the object detection system to capture finer details present in the camera or sensor data.

Even though sampling may be increased (up to 30 in this example) in specific areas 502, all BEV positions may still be covered, ensuring a comprehensive map.

In an aspect, every BEV position may have a corresponding one or more feature values, providing a complete picture of the environment.

The variable sample density in backward mapping may also be adapted to sensors with different optical properties, leading to a more efficient and informative BEV map. The vehicle may be equipped with multiple sensors, including a narrow FOV camera in addition to wider FOV cameras. Narrow FOV cameras may capture high-resolution details at a distance but may have a limited viewing/coverage area.

Wider FOV cameras typically capture a broader area but with potentially lower resolution for distant objects. In the BEV space, areas corresponding to the narrow FOV camera's range (further distances) may be assigned a higher sample density compared to areas closer to the vehicle. Such higher sample density may be achieved by dividing BEV positions in those areas into more sub-positions during the variable sample density process. In these areas with increased sample density, each cell (sample position) in the BEV space may be further divided into smaller sub-positions. This process may create a finer grid with more data points for representing intricate details.

In an aspect, by utilizing the variable sampling density technique for the narrow FOV range, the perception system 204 may design a sample pattern specifically for this camera. The designed pattern may have a higher density of sampling points towards the “further distances” captured by the camera. This better ensures the object detection system may capture the rich detail available in the narrow field of view of the FOV camera. For areas closer to the vehicle, where the wider FOV cameras may provide more information, the sample density may be lower, relying on the broader view of those sensors. In an aspect, different sensors may be utilized based on their strengths. Each sensor may get its own optimized sample pattern, maximizing the information extracted from its specific strengths. For example, narrow FOV may get more samples for distant details, while wider FOV may efficiently cover closer areas The perception system 204 may use the BEV map that may become richer by incorporating detailed information from the narrow FOV camera at a distance and broader coverage from the wider FOV cameras closer to the car.

FIG. 6 is a block diagram illustrating implementation of the backward mapping with variable sample density, in accordance with the techniques of this disclosure. As described, the disclosed implementation may maintain backward mapping's guarantee of sampling every output position at least once. Instead of a single sample per output position, the perception system 204 may design adaptable “sample patterns” that allow for variable sampling density. As the perception system 204 gets closer to sensors (areas 502 with potentially richer data), the perception system 204 may increase the sample frequency. The disclosed technique may capture the high-resolution information near the sensors that conventional backward mapping might miss. The disclosed technique may ensure no information gaps, just like backward mapping. At the same time, the disclosed technique may capture detailed data near sensors by increasing sampling frequency in those areas, similar to a well-designed forward mapping approach. In an aspect, perception system 204 may include two components: sample positions generator 205 and BMVT unit 207.

Sample position generator 205 may use calibration data 601 about the sensors (cameras, LiDAR, etc.) to understand their intrinsic and extrinsic parameters. Intrinsic parameters may define the internal characteristics of a sensor (e.g., focal length, distortion), while extrinsic parameters may define the position and orientation of the sensor relative to the vehicle. Based on the sensor calibration data 601 and the desired sample density strategy (variable in this case), the sample positions generator 205 may determine the specific locations (sample positions) within the perspective space of the sensor (camera image, LiDAR point cloud) where data will be extracted. For example, for areas with higher information density (e.g., close to the sensor in a camera image), the sample positions may be more densely packed using the variable sample density technique (dividing BEV positions into sub-positions). The BMVT unit 207 may use the actual sensor data itself. Per sensor perspective space features 602 may include, but are not limited to, image pixel intensities for a camera, distance measurements for LiDAR, etc.

Per sensor perspective space weights 604 may correspond to the importance assigned to each sample position within the perspective space of the sensor. Higher weights 604 may be assigned to areas with higher desired information density (e.g., sub-positions in the case of variable sample density).

In an aspect, the BMVT unit 207 may take the per-sensor data (perspective space features 602) and weights 604, along with the sample positions 606, and may be configured to perform the backward mapping process. The BMVT unit 207 may project the BEV space back onto perspective space of each sensor. The BMVT unit 207 may use the weights 604 to influence the contribution of each sample position 606 during the interpolation, potentially giving more weight to areas with higher information density. The output generated by the BMVT unit 207 may comprise the final BEV space feature map 608. The BEV space feature map 608 may contain a feature value for each BEV position, calculated based on the sensor data, weights 604, and backward mapping process. Another component of perception system 204 (e.g., a machine learning model such as object detection model) may be applied to the BEV space feature map 608. This model may use the processed features to generate the final perception output. The final perception output may be a classification (e.g., identifying objects in a scene) or a more complex representation like a depth map. To train the models involved, the ground truth data may be used. The ground truth data is data where the desired output is known for each sensor input. A loss function may compare the generated perception output with the ground truth. The loss function may quantify the difference between the model's prediction and the actual value. By minimizing this loss function through backpropagation, the machine learning model parameters may be adjusted to improve the accuracy of the perception output.

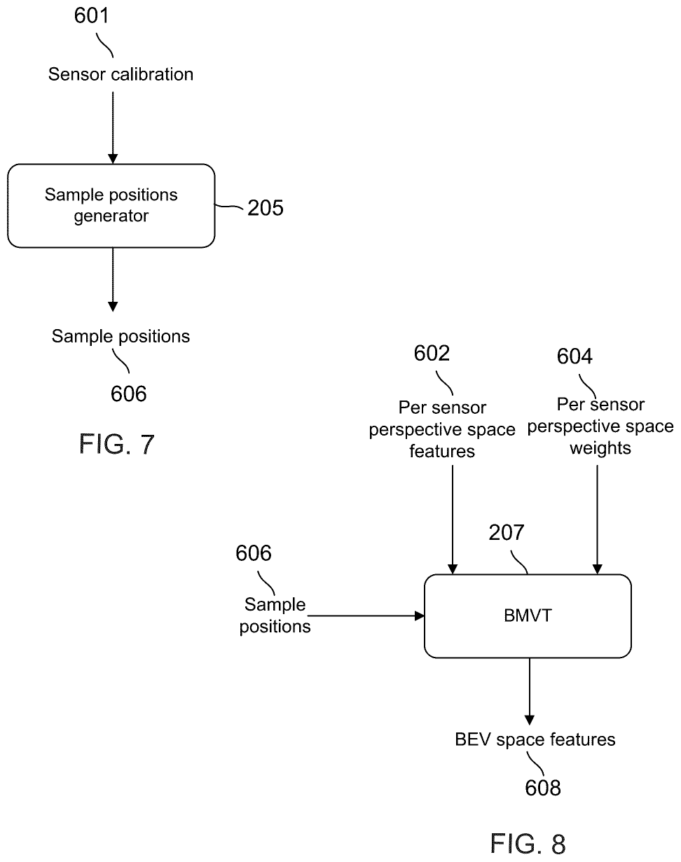

FIG. 7 is a block diagram illustrating generation of sensor sample positions, in accordance with the techniques of this disclosure. Sample positions generator 205 may receive information about a specific BEV output position and the sensor calibration data 601. The sample positions generator 205 may use the sensor calibration data 601 (intrinsic and extrinsic parameters) to understand the characteristics of the sensor and its relationship to the BEV space. The samples positions generator 205 may consider the desired sample density strategy, which in this case is variable. In other words, the sample density may be higher in areas close to the sensor in the BEV and potentially lower for areas further away. Based on the BEV position, sensor calibration data 601, and sample density strategy, the sample positions generator 205 may generate a list of sample positions 606 within the perspective space of the sensor.

For areas with high information density (e.g., close to the sensor in a camera image), the variable sample density technique may be applied. The variable sample density technique may involve dividing the BEV position into sub-positions, essentially creating a denser grid of sample locations within the sensor data. The sample positions generator 205 may output a list of sample positions 606 specific to the sensor for the given BEV output position. The list of sample positions 606 may be used later in the backward mapping process to extract data from the perspective space of the sensor.

In one non-limiting example, the sample positions generator 205 may implement variable sample density for generating sensor sample positions as described below. The sample positions generator 205 may iterate through each sensor for a given BEV position. The sample positions generator 205 may focus on those regions closest to the autonomous vehicle. These areas may be important for safe navigation as they represent the immediate surroundings with potential obstacles. In an aspect, sample positions generator 205 may use a variable sampling rate. As noted above, the BEV space may comprise a grid of squares. The term “sampling rate” as used herein, refers to the density of these squares. A higher sampling rate means more squares per unit area, resulting in a more detailed representation. The sampling rate determines the resolution of the BEV space grid. A higher sampling rate translates to more cells (sample positions) per unit area, resulting in a denser grid with more data points. In other words, the density of sample positions within the BEV space may not be uniform. For areas near the vehicle, the sampling rate may be increased. In simpler terms, the sample positions generator 205 may generate more sample positions within these important zones of the BEV space. By increasing the sampling rate near the vehicle, more points from the BEV space may be projected onto the perspective of the sensor. More sample points may translate to more data points being analyzed from the sensor data (camera image or LiDAR point cloud) in those important areas. For example, the sample positions generator 205 may use a function num_positions that may calculate the number of sub-positions (sample locations) needed within the perspective space of the corresponding sensor for this specific BEV position. Generally, the num_positions function may consider several factors, such as, but not limited to, the BEV position, sensor pose, and sensor FOV. For example, the BEV position may indicate the relative location of the BEV position in the environment. The sensor pose (obtained from sensor calibration data 601) may indicate the position and orientation of the sensor relative to the BEV space. The sensor FOV may indicate the inherent viewing angle of the corresponding sensor. In an aspect, the num_positions function may use a formula with parameters like alpha and sensor_fov to determine the number of sub-positions. In one example, the sample positions generator may use the following formula:

num_positions=clamp(round(alpha/(distance*sensor_fov)),1,max_num_positions)

In an aspect, the aforementioned formula involves calculations based on distance (e.g., between the BEV position and the sensor) and sensor properties. The number of sampled positions is inversely proportional to the distance between the sensor and the point of interest. In other words, as the distance increases, the number of samples decreases. Distant objects will appear smaller in the sensor data, so fewer samples are needed to capture their essential details. The clamp function may ensure that the number of sub-positions stays within a defined range (e.g., between 1 and max_num_positions). The clamp function may prevent excessive sampling for very close positions. Once the number of sub-positions is determined, the sample positions generator 205 may distribute the sub-positions within a “cell” corresponding to the BEV position. Such distribution could involve techniques like a grid pattern or a more sophisticated technique depending on the sensor type. Finally, the sample positions generator 205 may project these distributed sub-positions from the BEV space back onto the perspective space of the sensor (e.g., camera image or LiDAR point cloud). Such projection may be performed using techniques like, but not limited to, reverse perspective projection based on the sensor calibration data. The resulting sample positions in the sensor space may be floating-point values, allowing for precise sub-pixel sampling (important for cameras). In an aspect, a camera position may be represented by a specific column and row value with decimals instead of just integer coordinates.

As discussed earlier, forward mapping directly projects sensor data onto the BEV space. This approach can lead to sparse data in areas further away from the sensors. In alternative implementation, the sample positions generator 205 may utilize a large number of images 300 (shown in FIG. 3) for a specific sensor setup. Each image 300 may represent the number of distributed perspective view positions when using forward mapping. The purpose of collecting many samples is to capture the natural variations that occur due to sensor calibration and real-world conditions. In an aspect, sample positions generator 205 may fit a Mixture of Gaussians (MoG) model to the dataset of images 300. A MoG is a statistical technique that may represent a distribution as a combination of multiple Gaussian (bell-shaped) curves. By fitting a MoG, the sample positions generator 205 may learn the underlying structure of the image 300 data, which may reflect the natural distribution of objects in the environment. In an aspect, sample positions generator 205 may use the MoG to create image 500 shown in FIG. 5 by sampling points from the learned distribution. The MoG technique should result in a smoother and more natural distribution of sampling positions in image 500 compared to the potentially uneven distribution of the conventional techniques. The MoG technique may lead to a more natural radial distribution of samples around the vehicle, ensuring adequate coverage in all directions.

In an aspect, based on the estimated information density (derived from MoG variance), the samples position generator 205 may then determine the sampling frequency for that BEV position. Higher information density would lead to a higher sampling frequency. The disclosed technique may ensure that all BEV positions receive some data, leading to a dense overall map. For example, by analyzing MoG variances and adjusting sampling frequency, areas with richer information near the sensors could potentially be captured with more detail. Overall, using a mixture of Gaussians in a forward-mapping approach offers an alternative way to achieve variable sample density. However, the MoG technique may be computationally more expensive.

FIG. 8 is a block diagram illustrating generation of BEV space features, in accordance with the techniques of this disclosure. The input may include perspective space features 602. The perspective space features 602 may comprise the actual sensor data itself. The perspective space features 602 may include image pixel intensities for a camera, distance measurements for LiDAR, etc., for each sensor involved. The input may also include sample positions 606. Sample positions 606 may be the specific locations within each the perspective space of each sensor (generated by the sample positions generator 205) corresponding to a particular BEV position. Optionally, the input may further include perspective space weights 604. The perspective space weights 604 may be additional values (weights) that might be associated with each sample position 606. Higher weights 604 may indicate areas with higher desired information density.

In an aspect, the BMVT unit 207 may iterate through each sensor involved in the BEV position. For each sensor, the BMVT unit 207 may use the sample positions 606 to project those positions back onto the perspective space of the sensor (e.g., camera image, LiDAR point cloud). This is essentially backward mapping. Based on the projected sample positions 606, the BMVT unit 207 may extract the corresponding feature values from the sensor data (e.g., pixel intensities for a camera).

In yet another aspect, techniques like bilinear interpolation may be used to account for non-integer sample positions. If perspective space weights 604 are provided, the BMVT unit 207 may use the perspective space weights 604 to influence the contribution of each sampled feature value during the next step. Features with higher weights may have a greater impact on the final BEV space feature map 608. The BMVT unit 207 may generate a single feature value for the BEV position. The generated feature value may represent the combined information from all participating sensors, taking into account their sample positions 606 and potentially weights 604.

The weights 604 may be used by the BMVT unit 207 to prioritize detailed areas and to account for sensor confidence. The perception system 204 may estimate a likelihood or probability that a specific feature exists at a certain distance from a sensor column. This information may then be used as a weight 604 when interpolating the feature value at the desired output position. This weighting may “boost” or “dampen” the influence of specific data points based on the prediction of feature likelihood at that distance. During backward mapping, after projecting the output position onto the sensor space, the BMVT unit 207 may query the model for the likelihood of the desired feature at that specific distance within the sensor column. This likelihood may then be used to adjust the weight 604 of the interpolated value from that sensor. Assigning higher weights 604 to sample positions 606 closer to the sensors may emphasize detailed information captured by those sensors in the final BEV space feature map 608. If some sensors have higher confidence in their measurements for specific areas, the BMVT unit 207 may weight higher their corresponding sample positions 606 to reflect that confidence in the BEV feature.

As noted above, the sample positions generator 205 may generate sample positions 606 within the sensor space (camera image, LiDAR point cloud) as floating-point values. Floating-point sample positions 606 may allow for precise sub-pixel sampling, particularly for cameras. Each sample position 606 within the BEV space grid may hold a data value representing some property of the environment at that specific location. In this case, the data type mentioned is a floating-point value. Floating-point numbers may represent a wide range of numbers, including decimals, which are important in this scenario. For instance, the value at a sample position may represent distance to an object from the vehicle (e.g., 3.14 meters) or height of an object (e.g., 1.72 meters).

In other words, when using backward mapping with variable sampling density, the projected output position may fall between sensor data points (columns) rather than landing exactly on a data point. This is because the sensor data may have a fixed grid-like structure, while the output space the BMVT unit 207 is working with may use continuous floating-point positions. Using floating-point numbers for output positions may allow for precise representation of any location within the space, BMVT unit 207 may use linear interpolation for feature sampling. By knowing the distances between neighboring data points in the sensor grid (the separation between columns), the BMVT unit 207 may feed this information along with the projected output position into an interpolation function. The interpolation function may then use the surrounding data points from the sensor grid and their distances to the output position to estimate a value that best represents the sensor data at that specific location. This process may be applied to each sensor involved in covering the output position. By interpolating the data from each relevant sensor, the BMVT unit 207 may accumulate the information to generate a final output value within the feature map. In essence, the BMVT unit 207 may be using the known sensor data grid and the projected output position to intelligently estimate the value that would exist at that specific location within the field of view of the sensor, even if it does not directly correspond to a data point in the grid.

In an aspect, each BEV position may have multiple corresponding sample positions 606 within the perspective space due to variable sample density. To create a single feature value for the BEV position, the BMVT unit 207 may need to merge these sampled features.

In an aspect, the BMVT unit 207 may use one of the common reduction functions, such as but not limited to, max pooling, addition, mean and/or weighted mean. The max pooling function may reduce the dimensionality of the data by downsampling the input image while attempting to retain the most important features. The addition function may simply sum the feature values from all sample positions 606. The addition reduction function may be useful for features like object presence or occupancy where multiple positive detections reinforce the overall signal. The mean function may calculate the average of the feature values from all sample positions 606. The mean reduction function may provide a general representation of the information across the sampled area.

The weighted mean function may assign weights 604 to each sample position 606 before averaging. Higher weights 604 may be used for features with higher confidence or those closer to the sensor (in case of variable density). The weighted mean reduction function may allow for prioritizing specific information while merging. The choice of reduction function may depend on the specific type of feature being processed and the desired outcome for the BEV space feature map 608. In an aspect, for features related to object detection (e.g., object presence or bounding box coordinates), addition or weighted mean with weights favoring high-confidence detections may be suitable.

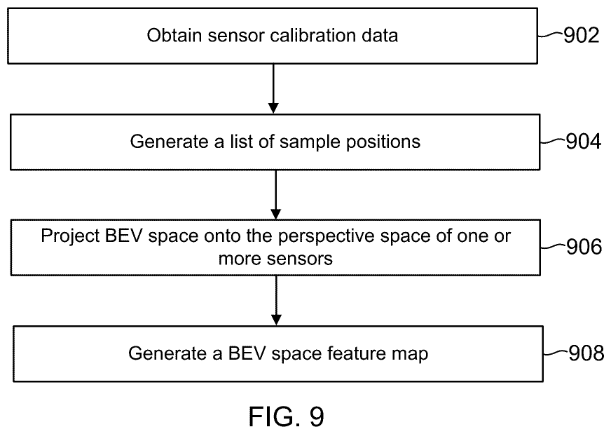

FIG. 9 is a flowchart illustrating an example method for generating a BEV space feature map in accordance with the techniques of this disclosure. Although described with respect to computing system 200 (FIG. 2), it should be understood that other devices may be configured to perform a method similar to that of FIG. 9.

In this example, perception system 204 may initially obtain sensor data from one or more sensor of vehicle 102 (902). Sensor data may include a plurality of characteristics of the one or more sensors 128-134. The perception system 204 may generate, based on the obtained sensor data, a list of sample positions within a perspective space of the one or more sensors that correspond to a location within BEV space (904). In one non-limiting example, the sample positions generator 205 may implement variable sample density for generating sensor sample positions as described above. The sample positions generator 205 may iterate through each sensor for a given BEV position. Next, the perception system 204 may project, based on the generated list of sample positions, the BEV space onto the perspective space of the one or more sensors using variable sample density (906). In an aspect, the perception system 204 may also divide a plurality of sensor sample positions into a plurality of sub-positions and may then project each of these sub-positions back onto the sensor space (cameras, LiDAR, etc.). The perception system 204 may generate BEV space feature map 608 using the BEV space projected onto the perspective space of the one or more sensors (908). Even though sampling may be increased (up to 30 in this example) in specific areas 502, all BEV positions may still be covered, ensuring a comprehensive BEV space feature map 608. The generated BEV space feature map 608, with its high-resolution areas, may become the primary source of information for the autonomous driving system 209 (e.g., ADAS system). The autonomous driving system 209 may analyze the feature map to understand the surrounding environment in detail, particularly focusing on the areas with increased sampling rate. Based on this detailed understanding, the autonomous driving system 209 may make decisions about appropriate actions. Such decisions may include, but are not limited to: warning the driver of potential hazards (e.g., pedestrians crossing the street); providing steering or braking assistance to maintain lane position or avoid collisions; adapting cruise control speed based on surrounding traffic.

The following numbered clauses illustrate one or more aspects of the devices and techniques described in this disclosure.

Clause 1—A method includes obtaining sensor calibration data related to one or more sensors of a vehicle; generating, based on the sensor calibration data, a list of sample positions within a perspective space of the one or more sensors that correspond to a location within Birds-Eye-View (BEV) space; projecting, based on the list of sample positions, the BEV space onto the perspective space of the one or more sensors using variable sample density; and generating a BEV space feature map using the BEV space projected onto the perspective space of the one or more sensors.

Clause 2—The method of clause 1, wherein the sensor calibration data comprises at least one of: one or more intrinsic parameters of the one or more sensors and one or more extrinsic parameters of the one or more sensors.

Clause 3—The method of clause 1, wherein projecting, based on the list of sample positions, the BEV space onto the perspective space of the one or more sensors using the variable sample density comprises: increasing a sampling rate in one or more areas of the BEV space corresponding to a plurality of locations near the one or more sensors.

Clause 4—The method of any of clauses 1-3, further comprising: dividing each sample position in the one or more areas of the BEV space having the increased sampling rate into a plurality of sub-positions; and projecting the plurality of sub-positions within the BEV space onto the perspective space of the one or more sensors.

Clause 5—The method of any of clauses 1-4, wherein the sample density is adapted based on the sensor calibration data.

Clause 6—The method of any of clauses 1-5, wherein the one or more sensors include one or more wide field of view cameras.

Clause 7—The method of any of clauses 1-6, further comprising operating an Advanced Driver Assistance Systems (ADAS) system based on the processed sensor data.

Clause 8—An apparatus for generating a Birds-Eye-View (BEV) space feature map, the apparatus comprising: a memory for storing sensor data; and processing circuitry in communication with the memory, wherein the processing circuitry is configured to: obtain sensor calibration data related to one or more sensors of a vehicle; generate, based on the sensor calibration data, a list of sample positions within a perspective space of the one or more sensors, wherein each of the sample positions corresponds to at least a location within BEV space; project, based on the list of sample positions, the BEV space onto the perspective space of the one or more sensors using variable sample density; and generate a BEV space feature map using the BEV space projected onto the perspective space of the one or more sensors.

Clause 9—The apparatus of clause 8, wherein the sensor calibration data comprises at least one of: one or more intrinsic parameters of the one or more sensors and one or more extrinsic parameters of the one or more sensors.

Clause 10—The apparatus of clause 8, wherein the processing circuitry configured to project, based on the list of sample positions, the BEV space onto the perspective space of the one or more sensors using the variable sample density is further configured to: increase a sampling rate in one or more areas of the BEV space corresponding to a plurality of locations near the one or more sensors.

Clause 11—The apparatus of any of clauses 8-10, wherein the processing circuitry is further configured to: divide each sample position in the one or more areas of the BEV space having the increased sampling rate into a plurality of sub-positions; and project the plurality of sub-positions within the BEV space onto the perspective space of the one or more sensors.

Clause 12—The apparatus of any of clauses 8-11, wherein the sample density is adapted based on the sensor calibration data.

Clause 13—The apparatus of any of clauses 8-12, wherein the one or more sensors include one or more wide field of view cameras.

Clause 14—The apparatus of any of clauses 8-13, wherein the processing circuitry is further configured to operate an Advanced Driver Assistance Systems (ADAS) system based on the processed sensor data.

Clause 15—Non-transitory computer-readable storage media having instructions encoded thereon, the instructions configured to cause processing circuitry to: obtain sensor calibration data related to one or more sensors of a vehicle; generate, based on the sensor calibration data, a list of sample positions within a perspective space of the one or more sensors, wherein each of the sample positions corresponds to at least a location within BEV space; project, based on the list of sample positions, the BEV space onto the perspective space of the one or more sensors using variable sample density; and generate a BEV space feature map using the BEV space projected onto the perspective space of the one or more sensors.

Clause 16—The non-transitory computer-readable storage media of clause 15, wherein the sensor calibration data comprises at least one of: one or more intrinsic parameters of the one or more sensors and one or more extrinsic parameters of the one or more sensors.

Clause 17—The non-transitory computer-readable storage media of clause 15, wherein the processing circuitry configured to project, based on the list of sample positions, the BEV space onto the perspective space of the one or more sensors using the variable sample density is further configured to: increase a sampling rate in one or more areas of the BEV space corresponding to a plurality of locations near the one or more sensors.

Clause 18—The non-transitory computer-readable storage media of any of clauses 15-17, wherein the processing circuitry is further configured to: divide each sample position in the one or more areas of the BEV space having the increased sampling rate into a plurality of sub-positions; and project the plurality of sub-positions within the BEV space onto the perspective space of the one or more sensors.

Clause 19—The non-transitory computer-readable storage media of any of clauses 15-18, wherein the sample density is adapted based on the sensor calibration data.

Clause 20—The non-transitory computer-readable storage media of any of clauses 15-19, wherein the one or more sensors include one or more wide field of view cameras.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules or units configured for encoding and decoding or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method for generating a Birds-Eye-View (BEV) space feature map comprising:
obtaining sensor calibration data related to one or more sensors of a vehicle;
generating, based on the sensor calibration data, a list of sample positions within a perspective space of the one or more sensors, wherein each of the sample positions corresponds to at least a location within BEV space;
projecting, based on the list of sample positions, the BEV space onto the perspective space of the one or more sensors using variable sample density; and
generating a BEV space feature map using the BEV space projected onto the perspective space of the one or more sensors.

2. The method of claim 1, wherein the sensor calibration data comprises at least one of:
one or more intrinsic parameters of the one or more sensors and one or more extrinsic parameters of the one or more sensors.

3. The method of claim 1, wherein projecting, based on the list of sample positions, the BEV space onto the perspective space of the one or more sensors using the variable sample density comprises:
increasing a sampling rate in one or more areas of the BEV space corresponding to a plurality of locations near the one or more sensors.

4. The method of claim 3, further comprising:
dividing each sample position in the one or more areas of the BEV space having the increased sampling rate into a plurality of sub-positions; and
projecting the plurality of sub-positions within the BEV space onto the perspective space of the one or more sensors.

5. The method of claim 2, wherein the sample density is adapted based on the sensor calibration data.

6. The method of claim 1, wherein the one or more sensors include one or more wide field of view cameras.

7. The method of claim 1, further comprising operating an Advanced Driver Assistance Systems (ADAS) system based on the generated BEV space feature map.

8. An apparatus for generating a Birds-Eye-View (BEV) space feature map, the apparatus comprising:
a memory for storing sensor data; and
processing circuitry in communication with the memory, wherein the processing circuitry is configured to:
obtain sensor calibration data related to one or more sensors of a vehicle;
generate, based on the sensor calibration data, a list of sample positions within a perspective space of the one or more sensors, wherein each of the sample positions corresponds to at least a location within BEV space;
project, based on the list of sample positions, the BEV space onto the perspective space of the one or more sensors using variable sample density; and
generate a BEV space feature map using the BEV space projected onto the perspective space of the one or more sensors.

9. The apparatus of claim 8, wherein the sensor calibration data comprises at least one of:
one or more intrinsic parameters of the one or more sensors and one or more extrinsic parameters of the one or more sensors.

10. The apparatus of claim 8, wherein the processing circuitry configured to project, based on the list of sample positions, the BEV space onto the perspective space of the one or more sensors using the variable sample density is further configured to:
increase a sampling rate in one or more areas of the BEV space corresponding to a plurality of locations near the one or more sensors.

11. The apparatus of claim 10, wherein the processing circuitry is further configured to:
divide each sample position in the one or more areas of the BEV space having the increased sampling rate into a plurality of sub-positions; and
project the plurality of sub-positions within the BEV space onto the perspective space of the one or more sensors.

12. The apparatus of claim 9, wherein the sample density is adapted based on the sensor calibration data.

13. The apparatus of claim 8, wherein the one or more sensors include one or more wide field of view cameras.

14. The apparatus of claim 8, wherein the processing circuitry is further configured to operate an Advanced Driver Assistance Systems (ADAS) system based on the processed sensor data.

15. Non-transitory computer-readable storage media having instructions encoded thereon, the instructions configured to cause processing circuitry to:
obtain sensor calibration data related to one or more sensors of a vehicle;
generate, based on the sensor calibration data, a list of sample positions within a perspective space of the one or more sensors, wherein each of the sample positions corresponds to at least a location within BEV space;
project, based on the list of sample positions, the BEV space onto the perspective space of the one or more sensors using variable sample density; and
generate a BEV space feature map using the BEV space projected onto the perspective space of the one or more sensors.

16. The non-transitory computer-readable storage media of claim 15, wherein the sensor calibration data comprises at least one of:
one or more intrinsic parameters of the one or more sensors and one or more extrinsic parameters of the one or more sensors.

17. The non-transitory computer-readable storage media of claim 15, wherein the processing circuitry configured to project, based on the list of sample positions, the BEV space onto the perspective space of the one or more sensors using the variable sample density is further configured to:
increase a sampling rate in one or more areas of the BEV space corresponding to a plurality of locations near the one or more sensors.

18. The non-transitory computer-readable storage media of claim 17, wherein the processing circuitry is further configured to:
divide each sample position in the one or more areas of the BEV space having the increased sampling rate into a plurality of sub-positions; and
project the plurality of sub-positions within the BEV space onto the perspective space of the one or more sensors.

19. The non-transitory computer-readable storage media of claim 16, wherein the sample density is adapted based on the sensor calibration data.

20. The non-transitory computer-readable storage media of claim 15, wherein the one or more sensors include one or more wide field of view cameras.
